(19) United States
(12) Patent Application Publication
(10) Pub. No.: US 2017/0098233 A1
(43) Pub. Date: Apr. 6, 2017

(54) SYSTEM AND METHOD OF COUPON REDEMPTION WITH AUTOMATED PROCEED INVESTMENT

(71) Applicants: Robert Bergman, Grafton, WI (US); Rick C. Bergman, Grafton, WI (US)

(72) Inventors: Robert Bergman, Grafton, WI (US); Rick C. Bergman, Grafton, WI (US)

(21) Appl. No.: 15/281,921

(22) Filed: Sep. 30, 2016

Related U.S. Application Data
(60) Provisional application No. 62/236,204, filed on Oct. 2, 2015.

(51) Int. Cl. G06Q 30/02; G06Q 20/20; G06Q 40/06

(52) U.S. Cl. CPC G06Q 30/0215; G06Q 40/06; G06Q 20/20; G06Q 10/1057

(57) ABSTRACT

A system and method for coupon redemption and automated proceed investment is disclosed. The system includes a management server that provides access to a merchant's transaction processing system and to individual member portals for registered customers. An input device is provided that is in operable communication with the management server, with the input device including a display with a user interface configured to display customer log-in and coupon redemption options to the customer and to receive log-in information and coupon redemption selections. A processor in the device is programmed to identify data relating to a customer designated account based on the log-in information provided by the registered customer, cause the user interface to display an electronic investment prompt for selecting a coupon redemption option, set aside an investment amount associated with the selected coupon redemption option, and finalize and transfer the investment amount into the customer designated account.

### CROSS-REFERENCE TO RELATED APPLICATION

The present application is a non-provisional of, and claims priority to, U.S. Provisional Patent Application Ser. No. 62/236,204, filed Oct. 2, 2015, the disclosure of which is incorporated herein by reference in its entirety.

### BACKGROUND OF THE INVENTION

The present invention is in the technical field of electronic commerce and relates generally to a retail electronic commerce system, and more specifically, a retail electronic commerce system of coupon redemption and automated proceed investment.

In today's world, a variety of financial investment programs exist to facilitate protecting consumer assets. Among these programs, long-term investment plans allow consumers/employees to save for their future/retirement within an expected period of time.

For example, a pension plan is an income arrangement that provides consumers deferred compensation following retirement. Pension plans typically are employment-based and may be classified as defined benefits, defined contributions, or a combination of both. Defined benefit plans involve the promise of an employer for a specific payout at retirement based on the employee's salary and length of membership in the plan (e.g., Individual Retirement Accounts (IRAs) and 401(k) plans where pre-defined investments are allocated from the employee's income). Similarly, with defined contribution plans, employers and/or employees contribute funds during employment; however, the payout at retirement is based on the performance of the investment and the amount of compensation is uncertain. Hybrid plan designs combine features of defined benefits as well as defined contributions (e.g., cash balance plans). When used correctly, these programs not only promote economic growth but also personal financial safety. Investing resources provides fixed capital (e.g., land, buildings, equipment) for the economy and potential gain for the investor.

Unfortunately, despite the potential reward of investing, many employees fail to establish any long-term investment plan at all. In some cases, these investment programs are not always available to a large portion of the population. Even where available, many employees/consumers lack the motivation to invest over a long period of time because it is difficult to visualize a high-expected return without sufficient investment expertise. Accordingly, transactions costs (e.g., fees, commission, and so on) are high and employees/consumers often are unwilling to accept the risk of investment for an unknown reward. Consumers thus may often opt to choose traditional savings accounts to preserve their income, with the downside being that such savings accounts earn much lower, fixed rates of return as compared to the potential gains achievable of other investments accounts and plans.

One method for encouraging savings is a program where users are influenced/enabled to set aside money during a consumer transaction process. For example, programs currently exist whereby consumers are allowed to save and/or donate a portion of a credit or debit transaction, such as described in U.S. Pat. No. 6,112,191 to Burke. In such systems, any credit or debit transaction is rounded up to the nearest dollar, with the consumer then directing the difference between the actual transaction price and the rounded amount into a designated savings account. This approach creates excess funds from spending transactions and provides an immediate opportunity to set aside these assets at the point of sale, thereby reducing transaction costs to save.

While systems as described in Burke are effective for creating opportunities to defer assets, the consumer still must actively choose to allocate the excess funds into a surplus account. Accordingly, the consumer must be willing to accept a higher overall transaction cost as a trade-off to the benefit of saving assets, which in the current economic environment may be a difficult choice for consumers to make. Additionally, the rather small amount that is saved by rounding up to the nearest dollar may not, over time, amount to much of an asset allocation over time.

Accordingly, there is a need for an automated investment system that encourages a consumer to invest on a semi-regular basis, where the investment is not viewed by the consumer as an excess charge or fee added onto an existing transaction amount. It would further be desirable for such an automated investment system to enable the consumer to select from a number of different investment contribution/allocation sizes, so as to allow the consumer to customize their investment to a desired amount. Embodiments of the invention are thus directed to systems and methods that allow financial investment providers and retailers to encourage individuals to invest with the money saved when using coupons to make a purchase at a retailer.

### BRIEF DESCRIPTION OF THE INVENTION

In accordance with one aspect of the invention, a retail electronic commerce system for coupon redemption and automated proceed investment is provided. The system includes a management server configured to provide access to a merchant's transaction processing system and to individual member portals of each of a plurality of registered customers and an input device in operable communication with the management server via an associated network. The input device includes a display with a user interface generated thereon configured to display customer log-in and coupon redemption options to the registered customer and to receive registered customer log-in information and coupon redemption selections. The input device further includes a processor operably connected to the display, with the processor being programmed to identify data relating to a customer designated account based on registered customer log-in information provided by the registered customer, cause the user interface to display an electronic investment prompt to the registered customer for selecting a coupon redemption option for a pending transaction, set aside an investment amount associated with the selected coupon redemption option for electronic processing and investment, and finalize and transfer the investment amount into the customer designated account.

In accordance with another aspect of the invention, a computer-implemented method for coupon redemption and automated proceed investment is provided. The method includes a step of generating a system log-in prompt on a display of an input device, the system log-in prompt being generated prior to or during processing of a customer transaction by a merchant's transaction processing system. The method also includes steps of receiving a log-in from a registered customer via the input device to provide access to a customer designated account associated with the registered user and generating a system coupon redemption prompt on the display of the input device, the coupon redemption prompt enabling selection of a coupon redemption option for a pending transaction by the registered customer. The method further includes steps of receiving selection of the coupon redemption option from the registered customer via the input device, designating via the input device an investment amount associated with the selected coupon redemption option for electronic processing and investment in the customer designated account, and finalizing and transferring the investment amount from the customer designated account into the customer designated account via the input device.

### BRIEF DESCRIPTION OF THE DRAWINGS

The drawings illustrate embodiments presently contemplated for carrying out the invention.

In the drawings:

FIG. 1 is a diagram of a coupon redemption and automated proceed investment system, according to an embodiment of the invention.

FIG. 2 is a flowchart illustrating a process for coupon redemption and automated proceed investment using the system of FIG. 1.

FIG. 3 is a diagram of a networked computer system upon which the system of FIG. 1 can be implemented.

FIG. 4 is a diagram of exemplary computer devices usable with the networked computer system of FIG. 3.

### DETAILED DESCRIPTION

Embodiments of the present invention are in the technical field of electronic commerce and relate generally to a retail electronic commerce system, and more specifically, a retail electronic commerce system of coupon redemption and automated proceed investment.

It is recognized that use of the term “coupon” throughout the application encompasses a number of coupon types and coupon redemption options. That is, the term “coupon” is understood to include paper coupons presented to a merchant for redemption, as well as digital coupons redeemed by the purchaser, such as via scanning of a digital coupon on a mobile device carried by the purchaser or via scanning of a purchaser store membership card having digital coupons downloaded to or associated therewith. In still another embodiment, the term “coupon” includes an image of a (paper) coupon stored on a mobile device that is displayed/presented to the merchant for redemption. Accordingly, use of the term “coupon” throughout the application is not meant to limit the scope of the invention to any particular type/form of coupon and/or means of redeeming thereof.

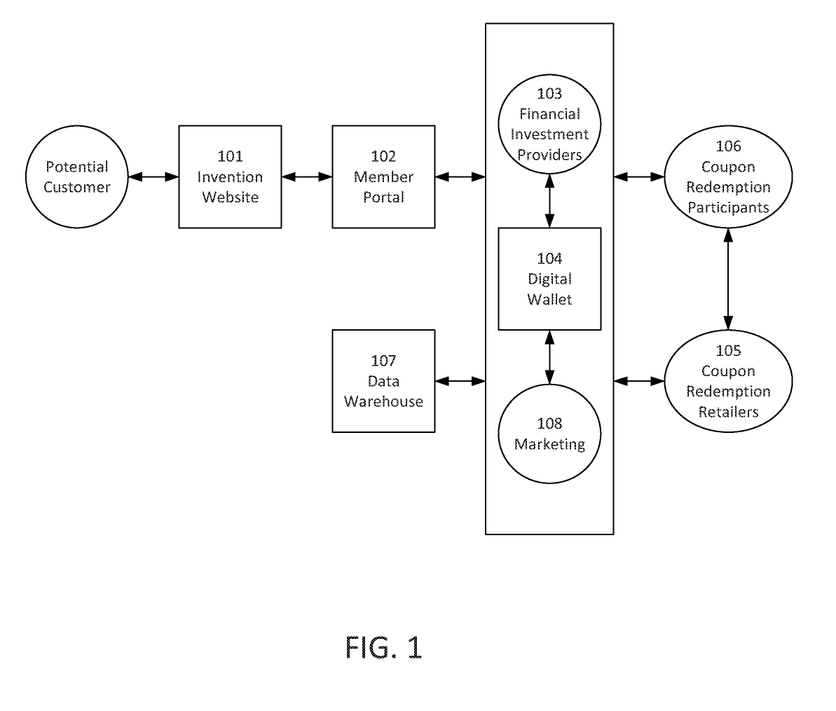

FIG. 1 illustrates a coupon redemption and automated proceed investment system (i.e., “the system”) 100, according to an embodiment of the invention. The system 100 includes a website 101 that may be accessed by both registered customers and potential customers to set-up and/or manage an account for coupon redemption and automated proceed investment. The website 101 offers information about, but not limited to, the invention's operating entity, contact information, offerings, instructions, functionality, restrictions, membership details, partners, and topical new items. Via the website 101, a registered customer may access a portfolio database representing financial investment fund options and information thereon, including both individual and collective investment funds. In one embodiment, portfolio database includes collective investment scheme options, such as various index funds. As an example of a collective investment scheme, Index Funds Advisors (IFA) offer Index Portfolios, which are individualized and indexed funds to replicate the movement of an index of a specific financial market. Alternatively, portfolio database may represent other investment schemes, such as, social conscious funds, exchange-traded funds (ETF), mutual funds, fund of funds (FOF), pre-constructed portfolios, and so on.

The system 100 also includes a member portal 102 that is only accessible to registered customers. A potential customer may become a registered customer by creating an account in the system. Creating the account may include providing demographic information, providing detailed information for potential coupon redemption that would be used to redeem coupons, and acknowledgment of disclaimer regarding how the system operates and uses information provided by the registered customer. It is contemplated that an annual, refundable membership fee may be charged.

Once a potential customer has become a registered customer, the registered customer is able to access the member portal 102. The member portal 102 is an e-commerce portal accessed through the website that is restricted to registered customers of the system 100. From the member portal 102, registered customers are able to view, update, and make changes to information such as, but not limited to, account history, preferences, registered investment options, topical news, and related information. Registered customers are able to view offerings and information from financial investment providers 103 for purposes of selecting an investment provider and investment vehicle with which to invest coupon redemption proceeds. For example, the financial investment providers offer information to registered customers concerning the risk and reward of different investments opportunities along with the associated return. The financial investment providers may include, but are not limited to, brokers, fund managers, banks, and investment houses. The registered customer is able to use the information regarding different investment opportunities to pre-select specific investment opportunities for automatic redemption.

When a registered customer is using a coupon or coupons at a retail point of sale of a coupon redemption partner 105, he may access the member portal 102 via an appropriate platform at the retail point of sale, such as an electronic payment device or other input screen or device—generically termed as an “input device.” In an exemplary embodiment, the payment/input device at the retail point of sale includes software thereon for the system 100, with it being recognized that the software is provided to mesh with existing software/hardware of the coupon redemption partner (i.e., the merchant or store). According to embodiments of the invention, the input device may be in the form of a point of sale (POS) terminal in a checkout line or a mobile device owned by the registered customer (e.g., mobile phones, laptop computers, personal digital assistants (PDA), and portable multimedia players), with each of such devices including therein/thereon a display, processor, and storage medium. The POS input terminal may be configured to support both contactless and direct transactions/data exchange including, for example, near field communication (NFC) device readers (such as might be used with a mobile device), credit/debit card readers, smart card readers, radio frequency identification (RFID) tag readers, and so on. During a typical consumer transaction, merchants exchange goods or services for payment from a consumer. Payment from the consumer may be linked to a consumer bank account (i.e., checking account), credit card, or online account-based system—such as those available from PayPal, Apple, and Google—that allow consumers to securely transfer electronic payments from numerous financial accounts.

In an embodiment where the customer utilizes a mobile device to access the mobile portal and provide payment for a pending transaction, the consumer transmits electronic payment information using the mobile device, such as by NFC transmission for example. The consumer may touch, or bring into close proximity (e.g., usually a few centimeters), their consumer device to the POS terminal to make purchases. This triggers an NFC communication with an application in the mobile device through an NFC antenna, with the mobile device providing payment information to the POS terminal and the POS terminal subsequently transmitting the payment information to a transaction gateway server, thereby creating an electronic payment gateway. As those of ordinary skill in the art would appreciate, payment gateways are application service providers to process and authorize the payment information.

Thus, in addition to making a transaction payment via the payment/input device, the payment/input device also enables the customer to log-in to their account and link the present POS purchase and coupon redemption to their account. Once the registered customer has redeemed all coupons, the redemption details are confirmed on the member portal 102. The registered customer may then choose—via the payment/input device—which redemption option they wish to use for that particular transaction. For example, the total redemption amount may be the full coupon redemption amount, a portion of the coupon redemption amount, no coupon redemption, or coupon redemption amount plus additional funds (such that the registered customer is able to make investment transactions in excess of the redeemed coupon value). The registered customer then pays the transaction amount less the total redemption amount by any appropriate method of payment—including credit card, debit card, cash, a mobile phone or other electronic payments devices. After the system verifies the funds, the total redemption amount is invested in pre-selected investment opportunities and prepayment is made to the financial investment provider. After investing is complete, the portal balance is debited for the type of investment, and amount of coupons redeemed. The coupons are considered to be redeemed, when the customer receives notice that the value of coupons presented, have been placed into an account—with such notice being provided via the point of sale payment/input device or via a mobile device of the user that is logged into the member portal 102.

Referring still to FIG. 1, it is seen that the system 100 also includes a digital wallet 104 accessible through the member portal 102. The digital wallet 104 is an electronic account structure that allows for the summary, virtual storage, and tracking of investments using the wallet. Access to the digital wallet 104 (via member portal 102) may be achieved via any of a variety of known devices/interfaces in order to allow a user to view/access the contents of the digital wallet 104, with authorized account access being provided using a telephone, the internet, point of sale or service displays, a payment card, key fob, mobile phone or other electronic payment devices.

In use of the system 100, it is recognized that—once a coupon or coupons have been redeemed and an amount selected by the user for investment—the firm selected for investment makes a claim for that value. The claim is made by interfacing the investment firm with the coupon redemption partner via the software installed at the point of sale, with an accounting for the amount of the coupons redeemed (or other user selected amount) then being made. To be included in this claim are any other participants in the coupon redemption process other than the final dispensing entity to the end user, who may be paid an agreed upon amount for each coupon redeemed through the invention.

It is recognized that the information supplied by the registered user and the registered user's transaction history provides valuable data regarding the registered user's needs, preferences, and patterns. As such, this information may be collected and stored in a data warehouse 107, and may be used to market a variety of products and services directly to the registered user, as is further shown in FIG. 1. This marketing 108 may be through a variety of mediums including, but not limited to, the member portal 102, mobile text messaging, mailings, and internet advertising. According to an embodiment of the invention, the data warehouse 107 is an electronic database that records, stores, and makes available for manipulation and analysis data or inferences from the data relating to, but not limited to registered user activity, information, preferences, needs, and transactions. This information may in turn be used to facilitate the targeted marketing of goods and services from financial investments providers and retailers.

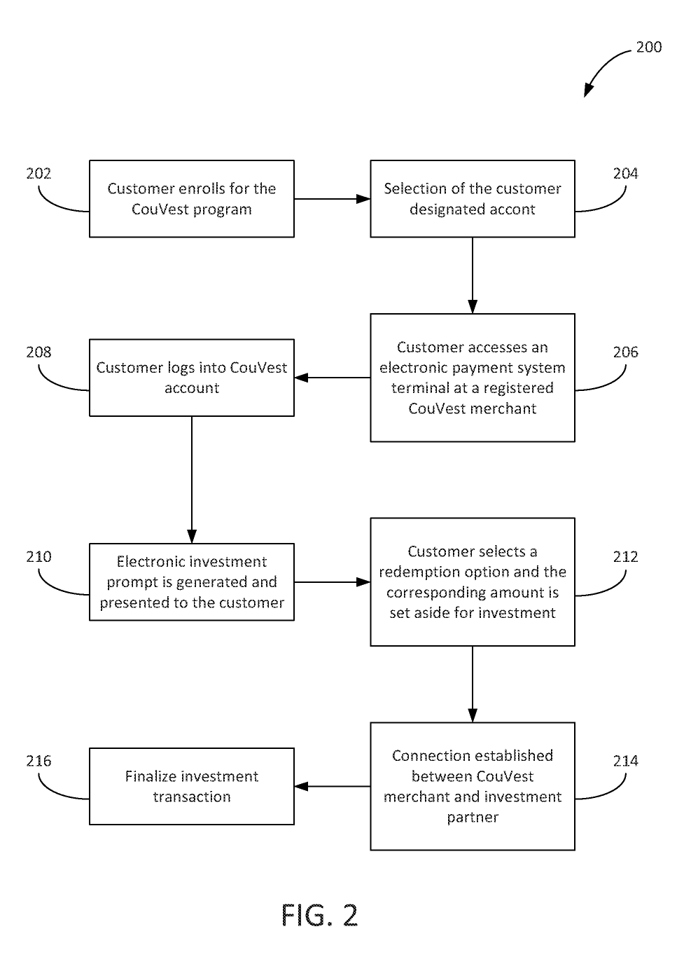

Referring now to FIG. 2, and with reference back to FIG. 1, a flowchart is provided illustrating a process 200 by which an investment transaction is made using the system of FIG. 1. In Step 202 of the process, registration with the system is accomplished when a customer enrolls, for example, online for the program using the website 101. It is envisioned that the steps that a consumer may take to enroll in the system are preferably conducted online, either at home via the website, but it is recognized that enrollment could be performed at a merchant location using a secure in-store input device. As set forth above, enrollment in the system includes selections by the registered customer of one or more investment funds into which a coupon redemption amount will be allocated, with enrollment thus including selection of investment funds from a portfolio database that may include collective investment scheme options (e.g., index funds), social conscious funds, exchange-traded funds (ETF), mutual funds, fund of funds (FOF), pre-constructed portfolios, and so on.

In Step 204, during selection of the customer designated account, the customer may register with any form of identification, even using a driver's license to enable cash EST transaction payments at the POS. Customer typically will also register and link to a new or existing checking account, allowing debit card EST payments to be made to the designated account. As one example, when registering the customer selects a preferred bank as the originator of a newly established EST registered savings account, perhaps because he shops at a particular merchant frequently and likes having the comfort and convenience of that merchant's in-store bank for its physical presence, customer service and other one-stop services.

In Step 206 the customer accesses an electronic payment system terminal when the customer goes to a registered merchant where he can use coupons and the proceeds therefrom to invest in his registered account. The merchant may display a logo (indicating it is a registered merchant) for its customers on their entrance doors, at the point-of-purchase register and on the terminal. The system log-in and message prompts are also visually displayed and advertised on the terminal screen whenever coupons are redeemed—with such redemption being of paper coupons, digital coupons and/or an image of a (paper) coupon stored on a purchaser's mobile device.

At Step 208, identifying data relating to a customer designated account is electronically accessed when the customer submits his registered information, for example, by typing in a user name/account number and password at the merchant's point of sale terminal in a checkout line. Most typically, this occurs when the customer beings the check-out procedure and before any coupons are redeemed or items scanned.

In Step 210, an electronic investment prompt is automatically generated and linked to the merchant's transaction processing system. The merchant's transaction processing system ensures that the transaction is encrypted for security, and then sends an electronic message to the central network through the store's processing system. Once authenticated, an automated prompt is then displayed instructing the registered customer to choose—via the terminal or payment/input device—which redemption option they wish to use for that particular transaction. For example, the total redemption amount may be the full coupon redemption amount, a portion of the coupon redemption amount, no coupon redemption, or coupon redemption amount plus additional funds (such that the registered customer is able to make investment transactions in excess of the redeemed coupon value).

Step 212 occurs in response to the customer selecting a redemption option provided at the terminal. Whatever the selection, the corresponding amount is set aside for electronic processing and investment. In one embodiment, the customer may again be asked again to verify and authorize the investment amount.

In Step 214, a connection is established between the merchant's transaction processing system and the customer's designated investment partner/account, as designated at registration. Step 216 finalizes the investment transaction with the transfer of finds into the customer designated account, and confirmation. The network then forwards the result back to the merchant's transaction processing system and the POS terminal with confirmation to let the customer know the transaction has been approved. In one embodiment, the detailed transaction may be printed on the receipt.

Beneficially, the system 100 of FIG. 1—and associated process 200 of FIG. 2 performable thereby—provides a retail electronic commerce system of coupon redemption and automated proceed investment that allows a user to invest a desired amount into a registered investment account upon a redemption of one or more coupons at a store/business that is recognized as a coupon redemption partner. The system thus beneficially encourages a consumer to invest small amounts in a convenient, hassle-free manner, with the consumer having the flexibility to invest either part of the coupon savings, the entire coupon savings, or the coupon savings plus an additional amount in a financial investment plan, so as to provide a highly flexible investment mechanism.

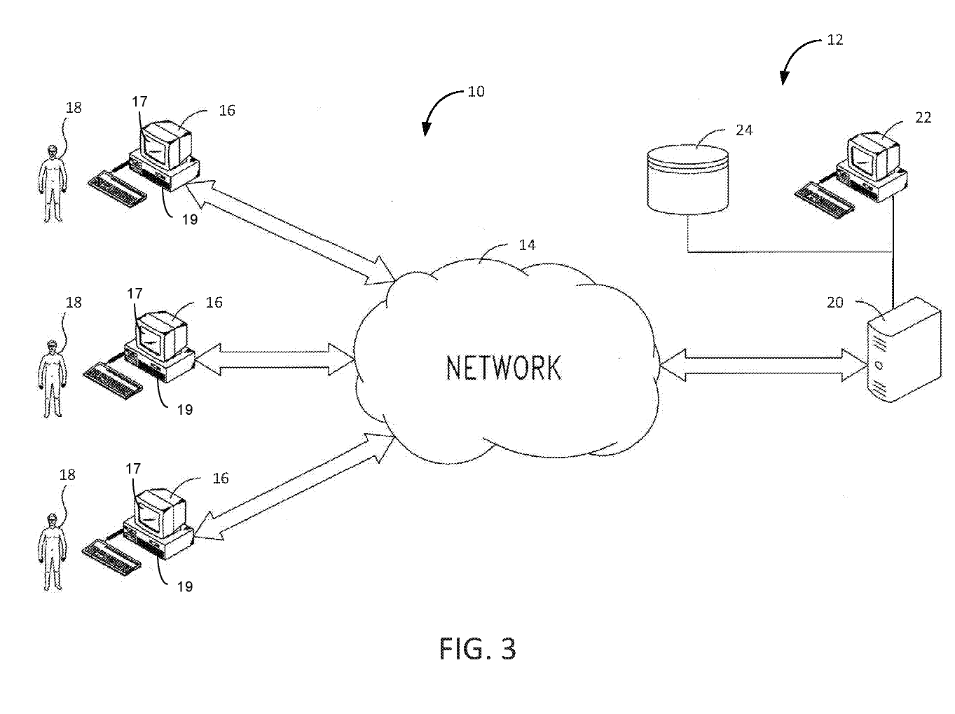

Referring now to FIG. 3, a networked computer system 10 upon which the system 100 of FIG. 1 and process 200 of FIG. 2 may be implemented at the facility of a coupon redemption partner is illustrated in order to more fully describe embodiments of the invention. The networked computer system 10 includes a management server 12, a network 14, and a plurality of input devices 16 accessible by a plurality of registered customers at the facility. The system runs on the management server 12 and provides access to individual member portals of each of the registered customers 18 as discussed above, with the network 14 being any type of network, such as the Internet or an extranet. With respect to input devices 16, each input device 16 includes a display 17 and processor 19 that collectively enable POS payment, registered customer log-in and member portal access, and coupon redemption capability. The input device display 17—via commands from processor 19—is configured to present/generate a user interface for the registered customer that is configured to display customer log-in and coupon redemption options to the customer and to receive customer log-in information and coupon redemption selections.

Each input device 16 may take a variety of forms which allow input and output by a user. For example, the devices 16 may take the form of a payment device or other user input device or display (e.g., an LCD display screen) at the retail point of sale. The devices 16 may be communicatively coupled to the network 14 via one or more networks, such as one or more wired (e.g., electrical conductors, optical fibers) networks and/or wireless networks via one or more wireless access points, for example. The input device may also take the form of a customer owned mobile device that communicates with a POS terminal to make payment and provides member portal access and coupon redemption capability.

The management server 12 may have one or more server computers 20 (only one illustrated) to provide electronic communications either externally with the network 14 and internally within the server 12. To handle the load of devices 16, the portfolio management server 12 will typically have more than one server computer 20. The management server 12 may include one or more terminals or personal computers 22 (only one shown), communicatively coupled to the server computer(s) 20 via one or more wired or wireless networks. The terminals or personal computers 22 allow input and output by an end user.

The management server 12 includes one or more non-transitory computer-readable storage media 24. The non-transitory computer-readable storage media 24 stores the system software that allows access to member portals and links the coupon redemption partner to user accounts and financial investment partners. In some implementations, the non-transitory computer-readable storage media 24 may be constituted by various types of storage media (e.g., hard drive, RAM).

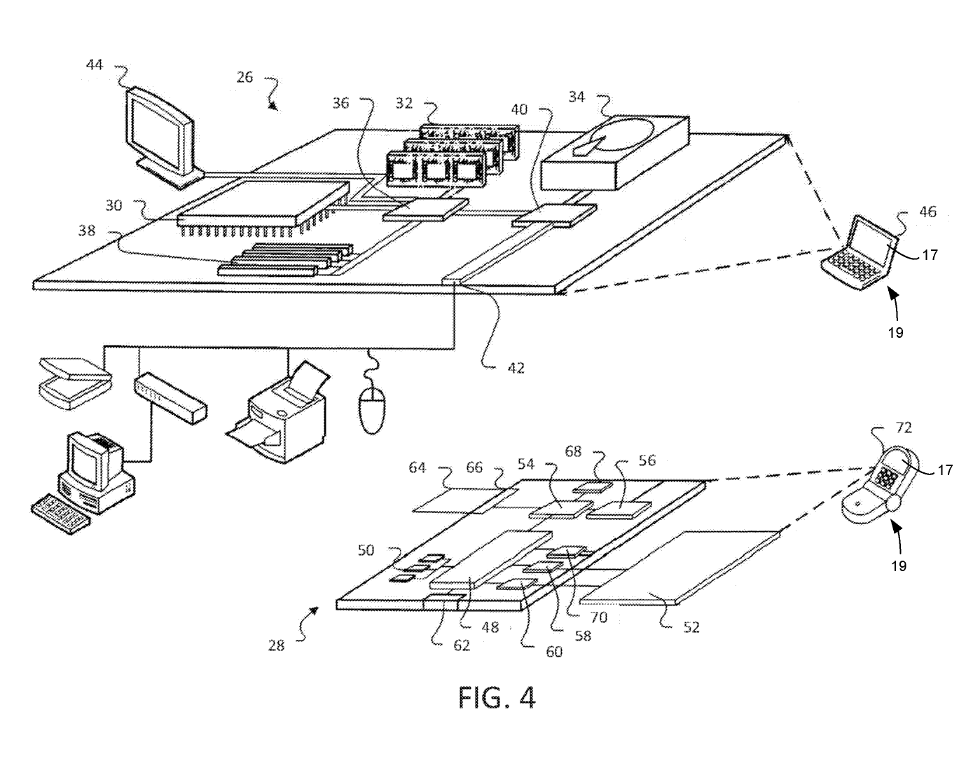

FIG. 4 shows two examples of generic computer devices 26, 28 useable with different aspects of the system 100 (FIG. 1). Device 26 in FIG. 4 may be understood to be interchangeable with computer device 16 of FIG. 2 and usable with the networked computer system 10 of FIG. 3. Device 26 is thus understood to represent various forms of computing, payment, input and/or display devices at the retail point of sale. Device 28 is intended to represent various forms of mobile devices that might be used to access the member portal 102 (FIG. 1) and/or digital wallet 104 (FIG. 1) of the system 100 (FIG. 1), such as personal digital assistants, a mobile phone, and other similar computing devices. The components shown here, their connections and relationships, and their functions, are meant to be exemplary only, and are not meant to limit implementations of the inventions described and/or claimed in this document.

Device 26 includes a processor 30, memory 32, a storage device 34, a high-speed interface 36 connecting to memory 32 and high-speed expansion ports 38, and a low-speed interface 40 connecting to low-speed bus 42 and storage device 34. Each of the components 30, 32, 34, 36, 38, 40 are interconnected using various busses, and may be mounted on a common motherboard or in other manners as appropriate. The processor 30 can process instructions for execution within the device 26, including instructions stored in the memory 32 or on the storage device 34 to display graphical information for a GUI on an external input/output device, such as display 44 coupled to high-speed interface 36. In other implementations, multiple processors and/or multiple busses may be used, as appropriate, along with multiple memories and types of memory.

The memory 32 stores information within the device 26. In one implementation, the memory 32 is a volatile memory unit or units. In another implementation, the memory 32 is a non-volatile memory unit or units. The memory 32 may also be another form of computer-readable medium, such as a magnetic or optical disk.

The storage device 34 is capable of providing mass storage for the device 26. In one implementation, the storage device 34 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-storage medium, such as the memory 32, the storage device 34, or memory on processor 30.

The high-speed interface 36 manages bandwidth-intensive operations for the device 26, while the low-speed interface 40 manages lower bandwidth-intensive operations. Such allocation of functions is exemplary only. In one implementation, the high-speed interface 36 is coupled to memory 32, display 44 (e.g., through a graphics processor or accelerator), and to high-speed expansion ports 38, which may accept various expansion cards (not shown). In the implementation, low-speed interface 40 is coupled to storage device 34 and low-speed expansion port 42. The low-speed expansion port 42, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The device 26 may be implemented in a number of different forms, as shown in the figure. For example, it may be implemented as a computer 46.

Device 28 includes a processor 48, memory 50, an input/output device such as a display 52, a communication interface 54, and a transceiver 56, among other components. The device 28 may also be provided with a storage device, such as a micro-drive or other device, to provide additional storage. Each of the components 48, 50, 52, 54, 56 is interconnected using various busses, and several of the components may be mounted on a common motherboard or in other manners as appropriate.

The processor 48 can execute instructions within the device 28, including instructions stored in the memory 50. The processor may be implemented as a chipset of chips that include separate and multiple analog and digital processors. The processor may provide, for example, for coordination of the other components of the device 28, such as control of user interfaces, applications run by device 28, and wireless communication by device 28.

Processor 48 may communicate with a user 18 through control interface 58 and display interface 60 coupled to a display 52. The display 52 may be, for example, a TFT LCD (Thin-Film-Transistor Liquid Crystal Display) or an OLED (Organic Light Emitting Diode) display, or other appropriate display technology. The display interface 60 may comprise appropriate circuitry for driving the display 52 to present graphical and other information to a user. The control interface 58 may receive commands from a user and convert them for submission to the processor 48. In addition, an external interface 62 may be provided in communication with processor 48, so as to enable near area communication of device 28 with other devices. External interface 62 may provide, for example, for wired communication in some implementations, or for wireless communication in other implementations, and multiple interfaces may also be used.

The memory 50 stores information within the device 28. The memory 50 can be implemented as one or more of a computer-readable medium or media, a volatile memory unit or units, or a non-volatile memory unit or units. Expansion memory 64 may also be provided and connected to device 28 through expansion interface 66, which may include, for example, a SIMM (Single In Line Memory Module) card interface. Such expansion memory 64 may provide extra storage space for device 28, or may also store applications or other information for device 28. Specifically, expansion memory 64 may include instructions to carry out or supplement the processes described above, and may include secure information also. Thus, for example, expansion memory 64 may be provide as a security module for device 28, and may be programmed with instructions that permit secure use of device 28. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer-readable medium, such as the memory 50, expansion memory 64, memory on processor 48, or a propagated signal that may be received, for example, over transceiver 56 or external interface 62.

Device 28 may communicate wirelessly through communication interface 54, which may include digital signal processing circuitry where necessary. Communication interface 54 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 56. In addition, short-range communication may occur, such as using a Bluetooth, Wi-Fi, or other such transceiver (not shown). In addition, GPS (Global Positioning System) receiver module 68 may provide additional location-related wireless data to device 28, which may be used as appropriate by applications running on device 28.

Device 28 may also communicate audibly using audio codec 70, which may receive spoken information from a user and convert it to usable digital information. Audio codec 70 may likewise generate audible sound for a user, such as through a speaker, e.g., in a handset of device 28. Such sound may include sound from voice telephone calls, may include recorded sound (e.g., voice messages, music files, etc.) and may also include sound generated by applications operating on device 28.

The device 28 may be implemented in a number of different forms. For example, it may be implemented as a mobile phone 72, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

Elements of different implementations described herein may be combined to form other implementations not specifically set forth above. Elements may be left out of the processes, computer programs, Web pages, etc. described herein without adversely affecting their operation. Furthermore, various separate elements may be combined into one or more individual elements to perform the functions described herein.

Beneficially, embodiments of the invention thus provide a retail electronic commerce system and related method for coupon redemption and automated proceed investment. Using the coupon redemption and automated proceed investment system, a registered customer is able to access a member portal via a POS terminal or mobile device and link a present POS purchase and coupon redemption to their account. Upon a coupon redemption, the registered customer may choose (via the input device) a desired coupon redemption option, with a total redemption amount associated with the selected redemption option then being invested in a pre-selected investment account. After investing is complete, a portal balance is debited for the type of investment, and the amount of coupons redeemed. The coupon redemption and automated proceed investment system thus enables a consumer to make a desired investment transaction utilizing coupon savings, such that the investment is not viewed by the consumer as an excess charge or fee added onto an existing transaction amount. This is in comparison to existing systems and methods that enable savings/investments via rounding up a credit or debit transaction to the nearest dollar, with the consumer then directing the difference between the actual transaction price and the rounded amount into a designated account. The coupon redemption and automated proceed investment system thus presents an improvements over existing investment systems and methods associated with customer transactions, and presents a unique system and method for coupon redemption as a basis for investment allocation.

It would further be desirable for such an automated investment system to enable the consumer to select from a number of different investment contribution/allocation sizes, so as to allow the consumer to customize their investment to a desired amount. Embodiments of the invention are thus directed to systems and methods that allow financial investment providers and retailers to encourage individuals to invest with the money saved when using coupons to make a purchase at a retailer.

Therefore, according to one embodiment of the invention, a retail electronic commerce system for coupon redemption and automated proceed investment is provided. The system includes a management server configured to provide access to a merchant's transaction processing system and to individual member portals of each of a plurality of registered customers and an input device in operable communication with the management server via an associated network. The input device includes a display with a user interface generated thereon configured to display customer log-in and coupon redemption options to the registered customer and to receive registered customer log-in information and coupon redemption selections. The input device further includes a processor operably connected to the display, with the processor being programmed to identify data relating to a customer designated account based on registered customer log-in information provided by the registered customer, cause the user interface to display an electronic investment prompt to the registered customer for selecting a coupon redemption option for a pending transaction, set aside an investment amount associated with the selected coupon redemption option for electronic processing and investment, and finalize and transfer the investment amount into the customer designated account.

According to another embodiment of the invention, a computer-implemented method for coupon redemption and automated proceed investment is provided. The method includes a step of generating a system log-in prompt on a display of an input device, the system log-in prompt being generated prior to or during processing of a customer transaction by a merchant's transaction processing system. The method also includes steps of receiving a log-in from a registered customer via the input device to provide access to a customer designated account associated with the registered user and generating a system coupon redemption prompt on the display of the input device, the coupon redemption prompt enabling selection of a coupon redemption option for a pending transaction by the registered customer. The method further includes steps of receiving selection of the coupon redemption option from the registered customer via the input device, designating via the input device an investment amount associated with the selected coupon redemption option for electronic processing and investment in the customer designated account, and finalizing and transferring the investment amount from the customer designated account into the customer designated account via the input device.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A retail electronic commerce system for coupon redemption and automated proceed investment, the system comprising:
a management server configured to provide access to a merchant's transaction processing system and to individual member portals of each of a plurality of registered customers; and
an input device in operable communication with the management server via an associated network, the input device comprising:
a display comprising a user interface generated thereon, the user interface configured to display customer log-in and coupon redemption options to the registered customer and to receive registered customer log-in information and coupon redemption selections; and
a processor operably connected to the display, the processor being programmed to:
identify data relating to a customer designated account based on registered customer log-in information provided by the registered customer;
cause the user interface to display an electronic investment prompt to the registered customer for selecting a coupon redemption option for a pending transaction;
set aside an investment amount associated with the selected coupon redemption option for electronic processing and investment; and
finalize and transfer the investment amount into the customer designated account.

2. The system of claim 1 input device comprises a merchant's point of sale terminal in a checkout line.

3. The system of claim 1 wherein the input device comprises a mobile device of the registered customer.

4. The system of claim 1 wherein a coupon redeemed by the registered customer comprises one or more of paper coupons, digital coupons, and/or an image of a coupon stored on a mobile device.

5. The system of claim 1 wherein the coupon redemption option comprises one of a full coupon redemption amount, a portion of a coupon redemption amount, no coupon redemption, or a coupon redemption amount plus additional funds.

6. The system of claim 1 wherein the processor is further programmed to cause the display to generate a confirmation upon the finalizing and transferring of the investment amount from the customer designated account into the customer designated account.

7. The system of claim 1 wherein the processor is further programmed to cause the management server to establish a connection between the merchant's transaction processing system and an investment firm associated with the customer designated account, so as to provide for transfer of the investment amount.

8. The system of claim 7 wherein the management server comprises a non-transitory computer readable storage medium having stored thereon a computer program comprising instructions which, when executed by a computer, cause the computer to:
interface the merchant's transaction processing system to the investment firm; and
accept and process a claim from the investment firm for a coupon redemption amount selected by the registered customer.

9. The system of claim 1 wherein the management server comprises a non-transitory computer readable storage medium having stored thereon a computer program comprising instructions which, when executed by a computer, cause the computer to:
store transaction history data provided by the registered customer in a data warehouse, the transaction history data providing data on the registered customer's needs, preferences, and patterns; and
analyze the transaction history data to facilitate targeted marketing of goods and services from financial investments providers and retailers to the registered customer.

10. The system of claim 1 wherein the processor is further programmed to provide access to a digital wallet that includes a summary, virtual storage, and tracking of investments associated with the customer designated account.

11. The system of claim 1 wherein the user interface is presented via a member portal accessed through the input device.

12. A computer-implemented method for coupon redemption and automated proceed investment, the method comprising:
generating a system log-in prompt on a display of an input device, the system log-in prompt being generated prior to or during processing of a customer transaction by a merchant's transaction processing system;
receiving a log-in from a registered customer via the input device, the received log-in providing access to a customer designated account associated with the registered user via a member portal;
generating a system coupon redemption prompt on the display of the input device, the coupon redemption prompt enabling selection of a coupon redemption option for a pending transaction by the registered customer;
receiving selection of the coupon redemption option from the registered customer via the input device;
designating, via the input device, an investment amount associated with the selected coupon redemption option for electronic processing and investment in the customer designated account; and
finalizing and transferring the investment amount from the customer designated account into the customer designated account via the input device.

13. The method of claim 12 wherein generating the system log-in prompt comprises generating a system log-in prompt via a merchant's point of sale terminal in a checkout line.

14. The method of claim 12 wherein generating the system log-in prompt comprises generating a system log-in prompt via a mobile device of the registered customer.

15. The method of claim 12 wherein the coupon redemption option comprises one of a full coupon redemption amount, a portion of a coupon redemption amount, no coupon redemption, or a coupon redemption amount plus additional funds.

16. The method of claim 12 further comprising redeeming a coupon presented by the registered customer prior to selection of a coupon redemption option, the coupon comprising one or more of paper coupons, digital coupons, and/or an image of a coupon stored on a mobile device.

17. The method of claim 12 further comprising generating a confirmation upon the finalizing and transferring of the investment amount from the customer designated account into the customer designated account.

18. The method of claim 12 further comprising:
interface the merchant's transaction processing system to an investment firm associated with the customer designated account; and
accept and process a claim from the investment firm for a coupon redemption amount selected by the registered customer.

19. The method of claim 12 further comprising:
storing transaction history data provided by the registered customer in a data warehouse, the transaction history data providing data on the registered customer's needs, preferences, and patterns; and
analyzing the transaction history data to facilitate targeted marketing of goods and services from financial investments providers and retailers to the registered customer.

20. The method of claim 12 further comprising generating a user interface on the display upon accessing the member portal, the user interface configured to display customer log-in and coupon redemption options to the registered customer and to receive registered customer log-in information and coupon redemption selections.
